(19) United States
(12) Patent Application Publication
(10) Pub. No.: US 2006/0038944 A1
(43) Pub. Date: Feb. 23, 2006

(54) Mask, thin film transistor substrate, method of manufacturing the thin film transistor substrate using the mask, and display apparatus using the thin film transistor substrate

(75) Inventors: Jae-Hyun Kim, Suwon-si (KR); Kee-Han Uh, Yongin-si (KR); Won-Sang Park, Yongin-si (KR); Sang-Woo Kim, Suwon-si (KR); Jae-Ik Lim, Gangwon-do (KR); Irina Poundaleva, Yongin-si (KR); Sung-Eun Cha, Geoje-si (KR); Seung-Kyu Lee, Yongin-si (KR); Jae-Young Lee, Seoul (KR)

Correspondence Address: MacPherson Kwok Chen & Heid LLP;Suite 226, 1762 Technology, San Jose, CA, 95110, US

(73) Assignee: SAMSUNG ELECTRONICS CO., LTD., Suwon-si (KR)

(21) Appl. No.: 11/198,818

(22) Filed: Aug. 4, 2005

(30) Foreign Application Priority Data
Aug. 5, 2004 (KR) 2004-61766

(51) Int. Cl. G02F 1/1335

(52) U.S. Cl. 349/114

(57) ABSTRACT

A display apparatus includes a voltage applying unit formed on a base substrate. An organic layer having a plurality of micro lens parts is formed to expose an output terminal of the voltage applying unit. Each of the micro lens parts has an irregular shape of a different size to increase a light reflectance. A pixel electrode comprises a first electrode formed on the organic layer and a second electrode formed on an upper face of the first electrode. The second electrode has a light transmitting window partially formed on the second electrode. A second substrate comprises a common electrode corresponding to the pixel electrode. A liquid crystal layer is disposed between the first and second substrates. The display apparatus may improve a display quality by increasing an amount of a light reflected from the pixel electrode.

### CROSS REFERENCE TO RELATED APPLICATION

This application relies for priority upon Korean Patent Application No. 2004-61766 filed on Aug. 5, 2004, the contents of which are herein incorporated by reference in its entirety.

### BACKGROUND OF THE INVENTION

1. Field of the Invention

The present invention relates to a mask, a thin film transistor substrate, a method of manufacturing the thin film transistor substrate using the mask, and a display apparatus including the thin film transistor substrate. More particularly, the present invention relates to a mask capable of improving light reflectance, a thin film transistor substrate having an improved light reflectance, a method of manufacturing the thin film transistor substrate using the mask, and a display apparatus having the thin film transistor substrate.

2. Description of the Related Art

In general, a display apparatus converts an electrical signal that is processed by an information-processing device into an image.

Typically, types of display apparatuses include a cathode ray tube (CRT) display apparatus, a liquid crystal display (LCD) apparatus, and an organic light emitting display (OLED) apparatus.

The liquid crystal display apparatus is classified into a transmissive LCD, a reflective LCD and a reflective-transmissive LCD.

The transmissive LCD apparatus transmits an internal light generated by a light source such as a lamp through a liquid crystal layer to display an image. The reflective LCD apparatus reflects an externally provided light from an exterior to the LCD apparatus to display the image. The externally provided light is generated from an externally provided light source such as the sun, or a lighting instrument.

The reflective-transmissive LCD apparatus functions as the reflective LCD apparatus in a bright place. In contrast, the reflective-transmissive LCD apparatus functions as the transmissive LCD apparatus in a dark place, so that power consumption of the reflective-transmissive LCD decreases. In addition, the reflective-transmissive LCD can display an image in a dark place.

In general, the reflective-transmissive LCD apparatus includes a reflective electrode reflecting an externally provided light to display an image by reflecting the externally provided light. The reflective-transmissive LCD apparatus includes an embossing pattern formed on the reflective electrode. The embossing pattern scatters the externally provided light, and uniformizes a reflective angle of the externally provided light.

An image display quality of the reflective-transmissive LCD apparatus or the transmissive LCD apparatus mainly depends on a shape of the embossing pattern formed on the reflective electrode. Recently, it has been widely tried to reform the shape of the embossing pattern to improve the image display quality of the reflective-transmissive LCD apparatus.

### SUMMARY OF THE INVENTION

The present invention provides a mask to form an embossing pattern of a reflective-transmissive liquid crystal display apparatus and a reflective liquid crystal display apparatus.

The present invention also provides a thin film transistor substrate manufactured using the above-mentioned mask.

The present invention further provides a method of manufacturing the above-mentioned thin film transistor substrate.

The present invention additionally provides a display apparatus including the above-mentioned thin film transistor substrate.

In accordance with an aspect of the present invention, there is provided a mask including a transparent substrate and a plurality of light blocking patterns having irregular shapes. The shapes of the light blocking patterns are different from each other.

The light blocking pattern has internal angles that are different from each other so that each of the light blocking patterns has a different shape. Also, a distance between the light blocking patterns adjacent to each other is in a range of about 2.0 μm to about 4.0 μm, and the distance is substantially constant.

A size of the light blocking pattern is in a range of about 3.5 μm to about 5.5 μm, and the size of the light blocking pattern is preferably in a range of about 4.0 μm to about 5.0 μm.

The light blocking pattern has a substantially polygonal shape such as a triangular shape, a quadrangular shape, a pentagonal shape, etc., when viewed on a plane.

In accordance with another aspect of the present invention, there is provided a thin film transistor substrate. The thin film transistor substrate includes a base substrate, a voltage applying unit, an organic layer and a pixel electrode. The voltage applying unit is disposed on the base substrate. The organic layer includes a plurality of micro lens parts formed on the organic layer to expose an output terminal of the voltage applying unit. Each of the micro lens parts has an irregular shape to increase light reflectance. The pixel electrode includes a first electrode formed on the organic layer and a second electrode formed on an upper face of the first electrode. The second electrode includes a light transmitting window.

The micro lens part has a substantially polygonal shape such as a triangular shape, a quadrangular shape, and a pentagonal shape, when viewed on a plane.

The micro lens part has side lengths that are different from each other, and internal angles that are different from each other.

A distance between the micro lens parts adjacent to each other is substantially constant, and the distance between the micro lens parts adjacent to each other is in a range of about 2.5 μm to about 3.5 μm. The size of the micro lens is in a range of about 3.5 μm to about 5.5 μm.

The voltage applying unit includes a thin film transistor having an output terminal and a signal line electrically connected to the thin film transistor. Voltage is applied to the output terminal of the thin film transistor through the signal line at a predetermined time.

In accordance with still another aspect of the present invention, there is provided a method of manufacturing the above-mentioned thin film transistor substrate. A voltage applying unit having an output terminal is formed on a first substrate. An organic layer is formed on the first substrate to cover the voltage applying unit. A mask is arranged on an upper face of the organic layer. The mask comprises a plurality of light blocking patterns, each light blocking pattern having a substantially polygonal thin layer shape with different side lengths. The organic layer is exposed and developed through the light blocking patterns to form a micro lens part on the organic layer, and each of the micro lens parts has a different shape when viewed on a plane. A first electrode is formed on the upper face of the organic layer.

The light blocking pattern has a substantially polygonal shape such as a triangular shape, quadrangular shape and pentagonal shape when viewed on a plane.

The light blocking pattern has side lengths that are different from each other and internal angles that are different from each other.

A distance between the light blocking patterns adjacent to each other is substantially constant, and the distance between the light blocking patterns adjacent to each other is in a range of about 2.5 μm to about 3.5 μm. The area of the light blocking pattern is in a range of about 3.5 μm to about 5.5 μm.

In accordance with still another aspect of the present invention, there is provided a display apparatus. The display apparatus includes a thin film transistor substrate, a second substrate and a liquid crystal layer.

The thin film transistor includes a voltage applying unit formed on a first substrate, an organic layer and a pixel electrode. The organic layer has a plurality of micro lens parts formed on the organic layer to expose an output terminal of the voltage applying unit, and each of the micro lens parts has an irregular shape with a different size to improve a light reflectance. The pixel electrode includes a first electrode formed on the organic layer and a second electrode formed on an upper face of the first electrode, and the second electrode has a light transmitting window that is partially formed on the second electrode. The second substrate includes a common electrode corresponding to the pixel electrode, and the second substrate corresponds to the first substrate. The liquid crystal layer is disposed between the first and the second substrates.

The micro lens part has a substantially polygonal shape such as a triangular shape, quadrangular shape and pentagonal shape when viewed on a plane.

The micro lens part has side lengths that are different from each other and internal angles that are different from each other.

A distance between the micro lens parts adjacent to each other is substantially constant, and the distance between the micro lens parts adjacent to each other is in a range of about 2.5 μm to about 3.5 μm. A size of the micro lens part is in a range of about 3.5 μm to about 5.5 μm.

In accordance with the present invention, an amount of a light reflected from the embossing pattern formed on the reflective layer in the pixel electrode increases to improve a display quality of the display apparatus.

### BRIEF DESCRIPTION OF THE DRAWINGS

The above and other advantages of the present invention will become readily apparent by reference to the following detailed description when considered in conjunction with the accompanying drawings wherein:

FIG. 1 is a plan view illustrating a mask in accordance with an exemplary embodiment of the present invention;

FIG. 2 is a plan view illustrating a thin film transistor substrate in accordance with an exemplary embodiment of the present invention;

FIG. 3 is a cross-sectional view taken along a line I1-I2 in FIG. 2;

FIG. 4 is a cross-sectional view taken along a line II1-II2 in FIG. 2;

FIG. 5 is a plan view illustrating an embossing pattern having an anisotropic relaxation ratio of one;

FIG. 6 is a plan view illustrating an embossing pattern having an anisotropic relaxation ratio of 0.5;

FIG. 7 is a plan view illustrating an embossing pattern having an anisotropic relaxation ratio of zero;

FIG. 8 is a graph showing a light reflectance of a second electrode for anisotropic relaxation ratios of from one to zero;

FIG. 9 is a graph showing a light reflectance when varying a size of a micro lens part at an anisotropic relaxation ratio of one;

FIG. 10 is a cross-sectional view illustrating forming a voltage applying unit on a base substrate using a method of manufacturing a thin film transistor substrate in accordance with an exemplary embodiment of the present invention;

FIG. 11 is a cross-sectional view illustrating an organic layer formed on the base substrate using a method of manufacturing a thin film transistor substrate in accordance with an exemplary embodiment of the present invention;

FIG. 12 is a cross-sectional view illustrating a mask arranged on the base substrate by using a method of manufacturing a thin film transistor substrate in accordance with an exemplary embodiment of the present invention;

FIG. 13 is a cross-sectional view illustrating a patterned organic layer using a method of manufacturing a thin film transistor substrate in accordance with an exemplary embodiment of the present invention;

FIG. 14 is a cross-sectional view illustrating a pixel electrode formed on an upper face of the organic layer using a method of manufacturing a thin film transistor substrate in accordance with an exemplary embodiment of the present invention; and

FIG. 15 is a cross-sectional view illustrating a display apparatus in accordance with an exemplary embodiment of the present invention.

### DESCRIPTION OF THE EMBODIMENTS

The present invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second and third may be used herein to describe various elements, components, regions, layers and/or sections, these elements, components, regions, layers and/or sections should not be limited by these terms. These terms are only used to distinguish one element, component, region, layer or section from another region, element, component, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Mask

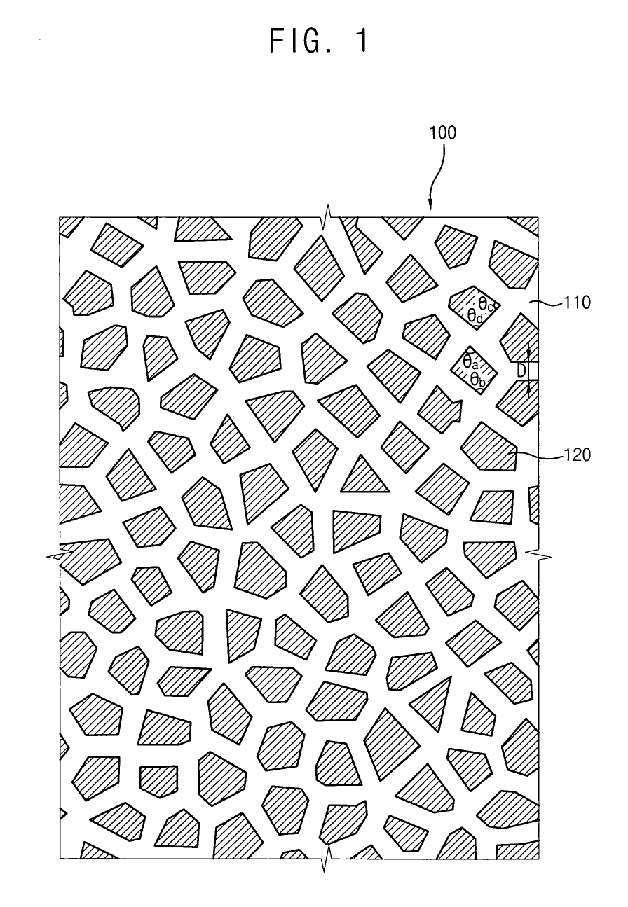

FIG. 1 is a plan view illustrating a mask in accordance with an exemplary embodiment of the present invention.

A mask in accordance with the present invention partially patterns a photosensitive film (or photosensitive-organic film), and a reflective electrode is formed on the patterned photosensitive film. Therefore, an embossing pattern is formed on the reflective electrode to enhance a light reflectance.

Referring to FIG. 1, the mask 100 includes a transparent substrate 110 and a plurality of light blocking patterns 120. In the present exemplary embodiment, the mask 100 has a structure suitable for exposing and developing a positive type photosensitive film.

The transparent substrate 110 includes a substrate having an excellent light transmittance. The transparent substrate may include, for example, a glass substrate.

The light blocking patterns 120 may be formed on the transparent substrate 110 or beneath the transparent substrate 110. The light blocking patterns 120 partially block a light incident to the transparent substrate 110.

Therefore, a shape of the light passing through the mask 100 is determined according to shapes of the light blocking patterns 120. Therefore, substantially same patterns as the light blocking patterns 120 are formed on a photosensitive film (not shown) under the mask 100.

In the present exemplary embodiment, the light blocking patterns 120 are formed on the transparent substrate 110. The light blocking patterns 120 are formed on the transparent substrate 110 in a thin film type, and have a substantially island shape when viewed on a plane. That is, the light blocking patterns 120 each have an irregular shape.

The light blocking patterns 120 have various shapes different from each other. The light blocking patterns 120, for example, each have a substantially polygonal shape such as a triangular shape, a quadrangular shape, a pentagonal shape, and a hexagonal shape when viewed on a plane. Alternatively, the light blocking patterns 120 may each have a substantially circular shape or an oval shape when viewed on a plane.

For example, although all the light blocking patterns 120 have similar shapes, each side of the light blocking pattern has a length at random so that the light blocking patterns 120 have different shapes from each other.

In addition, although all the light blocking patterns 120 have similar shapes, internal angles formed by neighboring two sides of the light blocking pattern 120 may be at random so that the light blocking patterns 120 have different shapes from each other.

Further, the light blocking patterns 120 may each have a substantially polygonal shape such as the triangular shape, the rectangular shape, or mixture thereof so that the light blocking patterns 120 have different shapes from each other. Each of the light blocking patterns 120 may have different side lengths, and the internal angles formed by neighboring two sides of the light blocking patterns 120 may be different from each other.

The light blocking patterns 120 adjacent to each other are spaced apart from each other by a distance. The distance is in a range of about 2.0 μm to about 4.0 μm. Also, the distance between the light blocking patterns 120 adjacent to each other is preferably substantially constant.

A size of the light blocking patterns 120 may be in a range of about 3.5 μm to about 5.5 μm, and is preferably in a range of about 4.0 μm to about 5.0 μm.

The distance between the light blocking patterns 120 adjacent to each other may be in a range of about 40% to 100% with respect to the size of the light blocking patterns 120.

For example, in the present embodiment, the size of the light blocking patterns 120 may be defined as described below.

When the light blocking patterns 120, for example, have a regularly hexagonal shape, the size of the light blocking patterns 120 is defined as the length between two vertexes opposite to each other.

When the light blocking patterns 120 have a substantially hexagonal shape, the size of the light blocking patterns 120 is defined as the average of the length between two vertexes which are opposite to each other.

The above manner to determine the size of the light blocking patterns may be also employed to the light blocking patterns 120 having various shapes.

The light blocking patterns 120 are formed on the substrate 110 in different shapes, so that micro lens parts (not shown) having different shapes from each other may be formed on a photosensitive layer (not shown) disposed under the mask 100. The light blocking patterns 120 have a size of about 3.5 μm to about 5.5 μm.

In addition, a reflective electrode having the embossing pattern substantially the same as the micro lens part, is formed on an upper face of the photosensitive layer, so that light properties of a light reflected from the reflective electrode may be enhanced.

Thin film Transistor Substrate

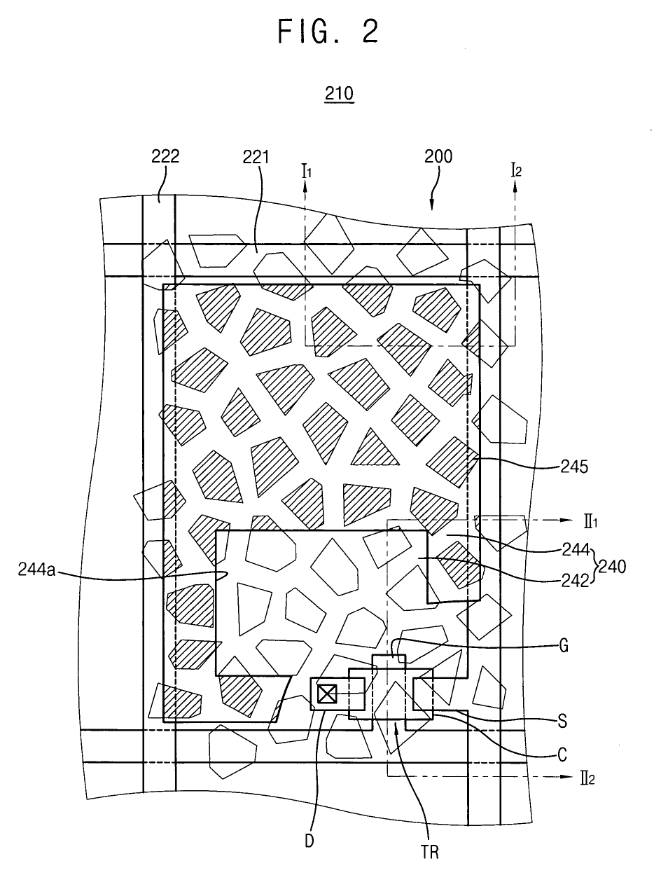

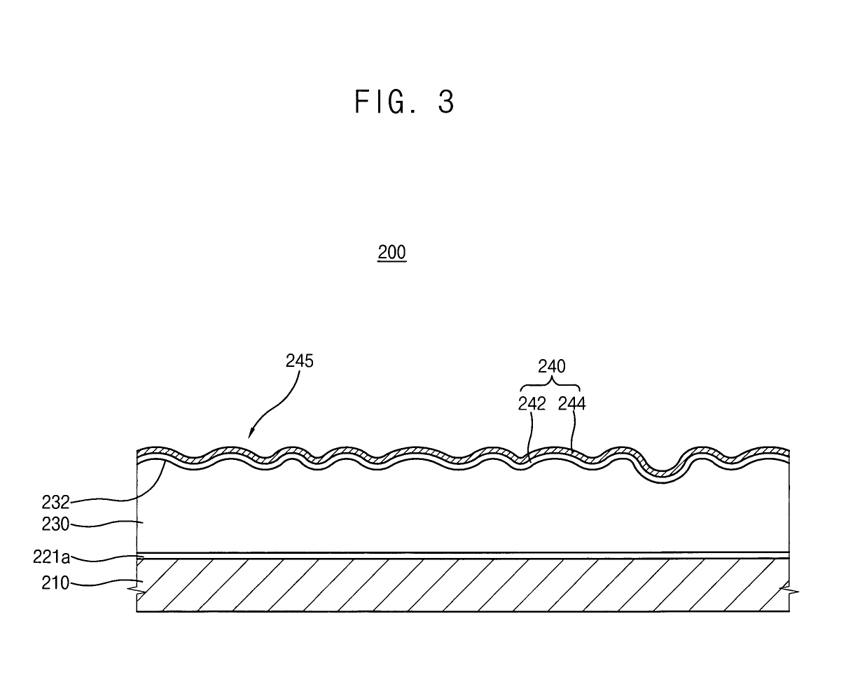

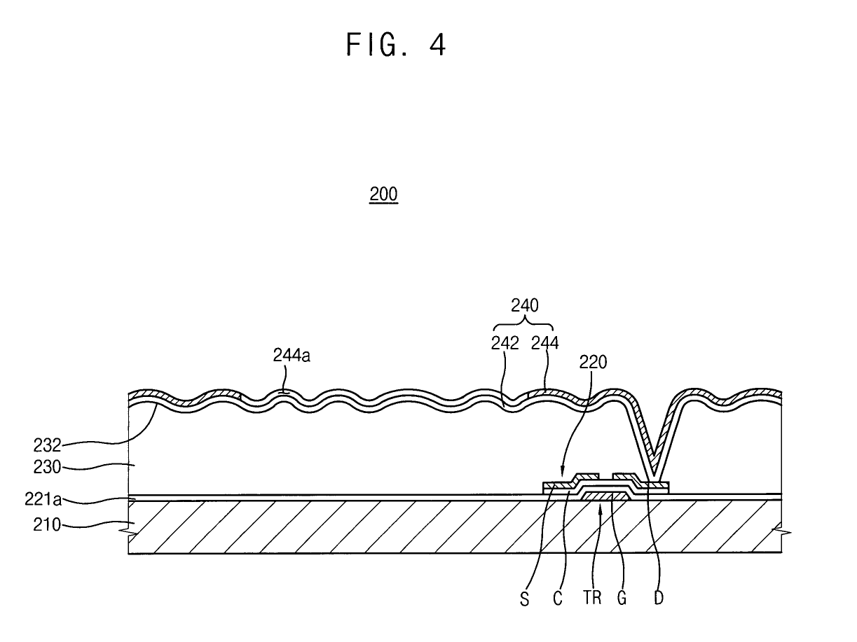

FIG. 2 is a plan view illustrating a thin film transistor substrate in accordance with an exemplary embodiment of the present invention. FIG. 3 is a cross-sectional view taken along a line I1-I2 in FIG. 2. FIG. 4 is a cross-sectional view taken along a line II1-II2 in FIG. 2.

Referring to FIG. 2 through FIG. 4, a thin film transistor substrate 200 includes a base substrate 210, a voltage applying unit 220 formed on the base substrate 210, an organic layer 230 and a pixel electrode 240.

In the present exemplary embodiment, the base substrate 210 may include a transparent substrate, for example, a glass substrate.

The voltage applying unit 220 includes a first signal line 221, a second signal line 222 and a thin film transistor TR including an output terminal.

The first signal line 221 is disposed on the base substrate 210, and is extended in a first direction, and a plurality of the first signal lines 221 are arranged in a second direction substantially perpendicular to the first direction.

For example, when the thin film transistor substrate 200 has a resolution of 1024×764, the first signal line 221 includes about seven hundred sixty one lines. The first signal line 221 outputs a turn-on signal or turn-off signal provided from an exterior to the thin film transistor TR.

The second signal 222 is disposed on the base substrate 210, and extends in the second direction, and a plurality of the second signal lines 222 are arranged in the first direction substantially perpendicular to the second direction.

For example, when the thin film transistor substrate 200 has a resolution of 1024×764, the second signal line 222 includes about 1024×3 lines. The second signal line 222 outputs a data signal provided from exterior to the thin film transistor TR.

The thin film transistor TR includes a gate electrode ‘G’, a channel layer ‘C’, a source electrode ‘S’ and a drain electrode ‘D’ that functions as an output terminal of the transistor TR.

The gate electrode ‘G’ of the thin film transistor TR is partially extended in the second direction from the first signal line 221. The gate electrode ‘G’ is insulated by an insulation layer 221a.

The channel layer ‘C’ is formed on the insulation layer 221a to cover the gate electrode ‘G’. The channel layer ‘C’ may include an amorphous silicon pattern including an amorphous silicon. Alternatively, the channel layer ‘C’ may include the amorphous silicon pattern and two n+amorphous silicon patterns formed on the amorphous silicon pattern.

The channel layer ‘C’ is converted into a conductor from a nonconductor by the turn-on signal inputted from the first signal line 221, and is also converted into the nonconductor from the conductor by the turn-off signal inputted from the first signal 221.

The source electrode ‘S’ is extended toward the channel layer ‘C’ from the second signal 222, and is electrically connected to an upper face of the channel layer ‘C’.

The drain electrode ‘D’ is disposed on the channel layer C, and is spaced apart from the source electrode ‘S’. The data signal applied to the second signal line 222 is outputted to the drain electrode ‘D’ through the channel layer ‘C’ having conductivity. The conductivity of the channel layer ‘C’ is generated by the turn-on signal applied to the first signal line 221.

The organic layer 230 is formed on the base substrate 210. The organic layer 230 includes a photosensitive material, and covers the voltage applying unit 220 formed on the base substrate 210. A portion of the organic layer 230 corresponding to the drain electrode ‘D’ of the voltage applying unit 220 is opened to expose the drain electrode ‘D’.

A plurality of micro lens structures 232 are formed on the organic layer 230, and the micro lens parts 232 have a substantially island shape when viewed on a plane. That is, the micro lens structures 232 each have an irregular shape.

More particularly, the micro lens part 232 has a polygonal shape such as a triangular shape, a quadrangular shape, or a pentagonal shape. For example, the micro lens parts 232 may each have the island shape including a triangular shape, a quadrangular shape, a pentagonal shape, or a mixture thereof.

In the present embodiment, the micro lens part 232 has sides having different lengths from each other, so that each of the micro lens parts 232 has a different shape. Alternatively, internal angles formed by neighboring two sides of the micro lens part 232 may be different from each other so that the micro lens parts 232 may have different shapes from each other.

Alternatively, all the micro lens parts 232 may each have a substantially same shape, but each micro lens part may have a different size.

The intervals between neighboring micro lens parts 232 are substantially constant, and the intervals between the neighboring micro lens parts 232 are in a range of about 2.5 μm to about 3.5 μm.

The size of the micro lens part 232 may be in a range of about 3.5 μm to about 5.5 μm, and the size of the micro lens part 232 is preferably in a range of about 4.0 μm to about 5.0 μm.

In the present embodiment, the intervals between the neighboring micro lens parts 232 are in a range of about 40% to about 100% with respect to the size of the micro lens part 232.

The pixel electrode 240 includes a first electrode 242 formed on the organic layer 230 and a second electrode 244 formed on an upper face of the first electrode 242.

In the present embodiment, the pixel electrode 240 includes the first and second electrodes 242 and 244. Alternatively, only the first electrode 242 may be formed on the organic layer 230.

In the present embodiment, the first electrode 242 is directly formed on the first organic layer 230a. The first electrode 242 includes, for example, an indium tin oxide (ITO) film, an indium zinc oxide (IZO) film, an amorphous indium thin oxide film, etc.

The second electrode 244 is formed on an upper face of the first electrode 242. The second electrode 244 includes a metal having an excellent light reflectance. The second electrode 244 includes, for example, aluminum, or an aluminum alloy. The second electrode 244 has a transmitting window 244a to partially expose the first electrode 242.

In the present embodiment, an embossing pattern 245 is formed on the first electrode 242 and the second electrode 244 formed on the first electrode 242. The embossing pattern 245 corresponds to the shapes of the micro lens parts 232.

Hereinafter, a relationship between the light reflectance and the shape of the embossing pattern 245 formed on the second electrode 244 will be explained.

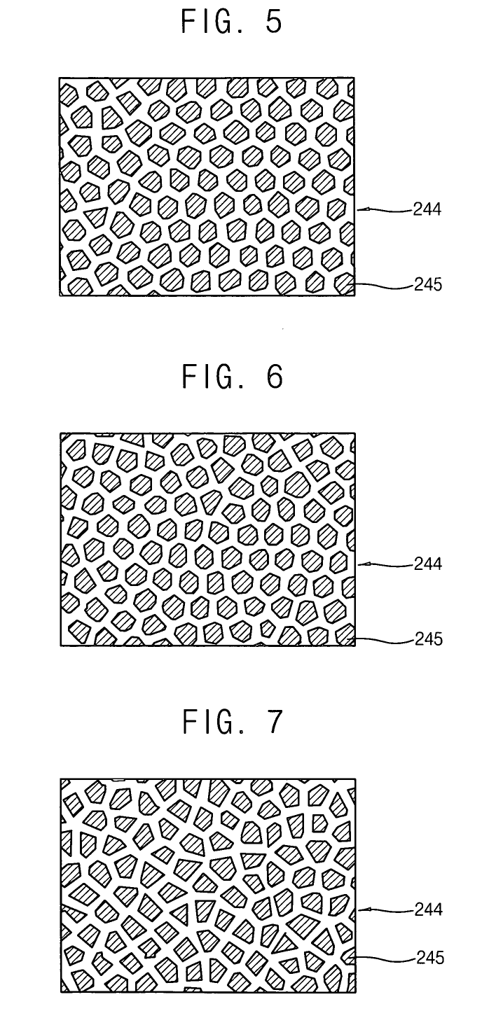

FIG. 5 is a plan view illustrating embossing patterns 245 having an anisotropic relaxation ratio (AR) of about one. FIG. 6 is a plan view illustrating embossing patterns having an anisotropic relaxation ratio of about 0.5. FIG. 7 is a plan view illustrating embossing patterns having an anisotropic relaxation ratio of zero.

Referring to FIG. 5 to FIG. 7, an anisotropic relaxation ratio (AR) of the embossing patterns 245 is determined in response to the shapes of the micro lens parts 232 formed on the organic layer 230.

In the present invention, the AR is determined by an optional method.

For example, the AR is defined as a ratio of micro lens parts 232 that have substantially same shapes from each other with respect to the total number of the micro lens parts 232.

Alternatively, the AR may be determined by another method. For example, when the micro lens part 232 has a substantially hexagonal shape, the AR may be determined by evaluating a deviation of the micro lens parts 232 having different shapes.

In the present embodiment, the AR of about one means that all the micro lens parts 232 have substantially identical shapes. For example, all the micro lens parts 232 have substantially hexagonal shapes. Also, the AR of about one means that all the micro lens part 232 may have substantially same lengths. In addition, the AR of about one means that the internal angles formed by the neighboring sides are substantially constant, and plane areas of the micro lens parts 232 are substantially constant.

The AR of about zero means that all the micro lens parts 232 formed on the organic layer 230 have different shapes. Also, the AR of about zero may mean all the sides of the micro lens part 232 have different lengths from each other. In addition, the AR of about zero may mean that the all the internal angles formed by the neighboring sides are different from each other, and plane areas of the micro lens parts 232 are different from each other.

The AR of 0.5 means that half of the micro lens parts 232 formed on the organic layer 230 have substantially identical shapes, and another half of the micro lens parts 232 have different shapes from each other. Also, the AR of about 0.5 may mean half of the sides of the micro lens part 232 have substantially identical lengths, and another half of the micro lens parts 232 have different lengths. In addition, the AR of about 0.5 may mean that the internal half of the angles formed by the neighboring sides are substantially constant, and another half of the angles formed by neighboring sides are different from each other. Also, half of the plane areas of the micro lens parts 232 are substantially constant, and another half of the plane areas of the micro lens parts 232 are different from each other.

Accordingly, when the AR is one, all the micro lens parts 232 have substantially same shapes and sizes. When the AR is zero, all the micro lens parts 232 have substantially different shapes and sizes. When the AR is 0.5, half of the micro lens parts 232 have substantially same shapes and sizes, and another half of the micro lens parts 232 have substantially different shapes and sizes.

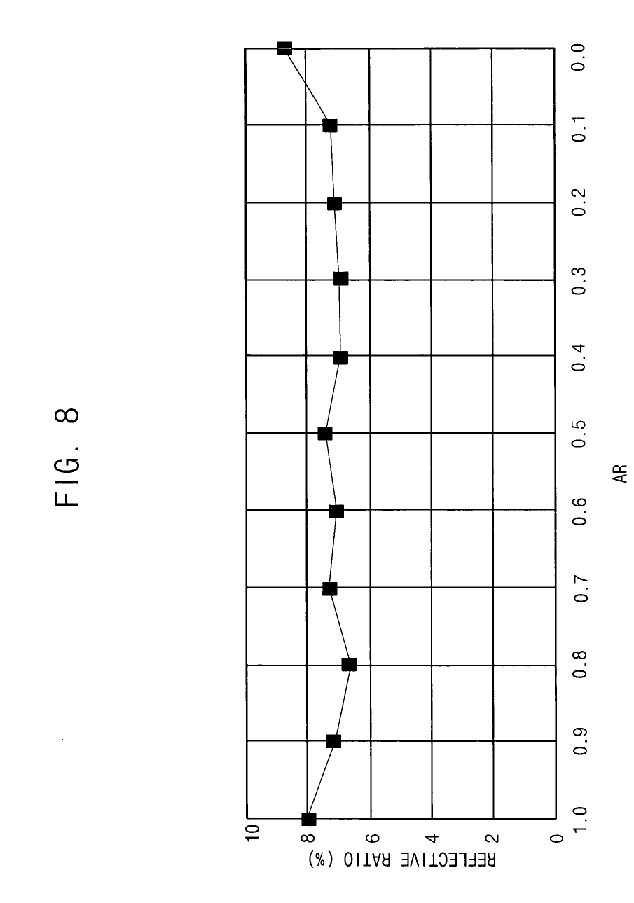

FIG. 8 is a graph showing light reflectance of a second electrode when varying an anisotropic relaxation ratio from one to zero.

Referring to FIG. 8, the reflectance was not largely changed when varying an anisotropic relaxation ratio from one to zero, and the reflectance was at the highest when the AR was zero.

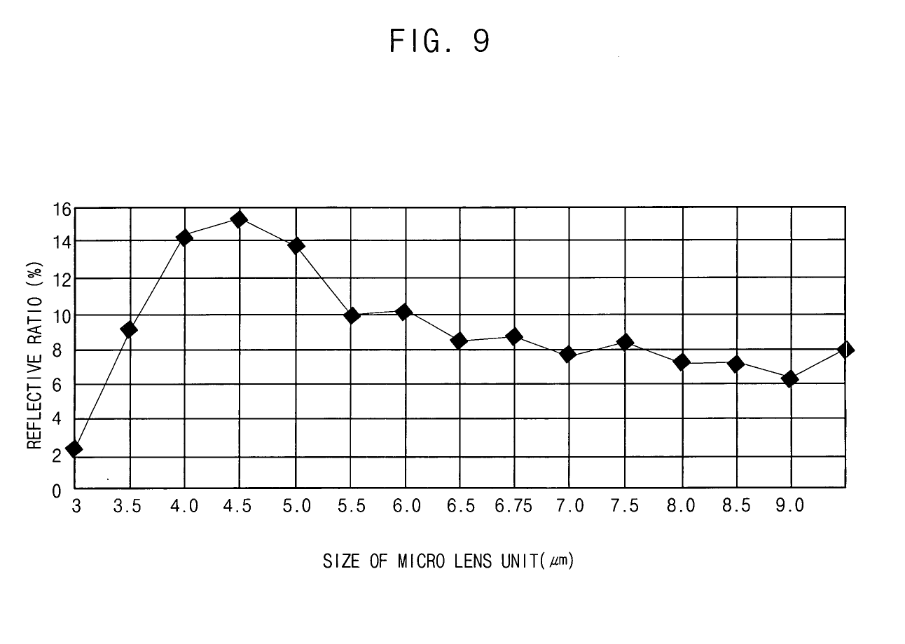

FIG. 9 is a graph showing light reflectance when varying a size of a micro lens part, of which an anisotropic relaxation ratio is one.

Referring to FIG. 9, the reflectance of the embossing pattern 245 was changed corresponding to the size of the micro lens parts 232 formed on the organic layer 230.

The light reflectance of the second electrode 244 was evaluated, and the light reflectance of the second electrode 244 was relatively high in a range of about 3.5 μm to about 5.5 μm.

When the size of the micro lens part is less than about 3.5 μm, the shape of the micro lens part 232 may be difficult to control precisely. When the size of the micro lens part 232 exceeds about 5.5 μm, a surface area of the micro lens part 232 decreases, thereby decreasing the light reflectance.

In order to maximize the light reflectance of the second electrode 244, the size of the micro lens part 232 is preferably in a range of about 4.0 μm to about 5.0 μm.

Therefore, the AR of the embossing pattern 245 is substantially zero, and the size of the micro lens part 232 is in a range of about 3.5 μm to about 5.5 μm so as to enhance the light reflectance of the second electrode 244.

Method of Manufacturing a Thin Film Transistor Substrate

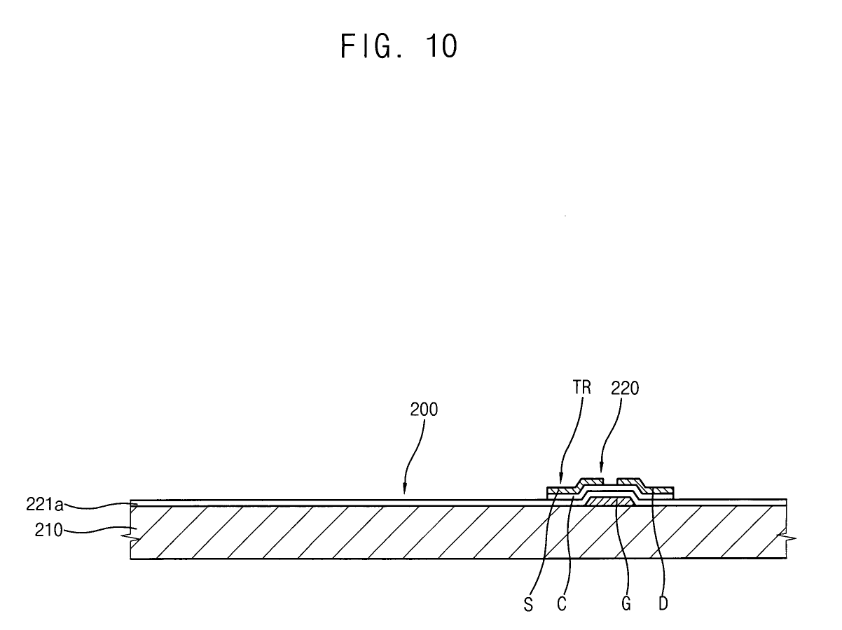

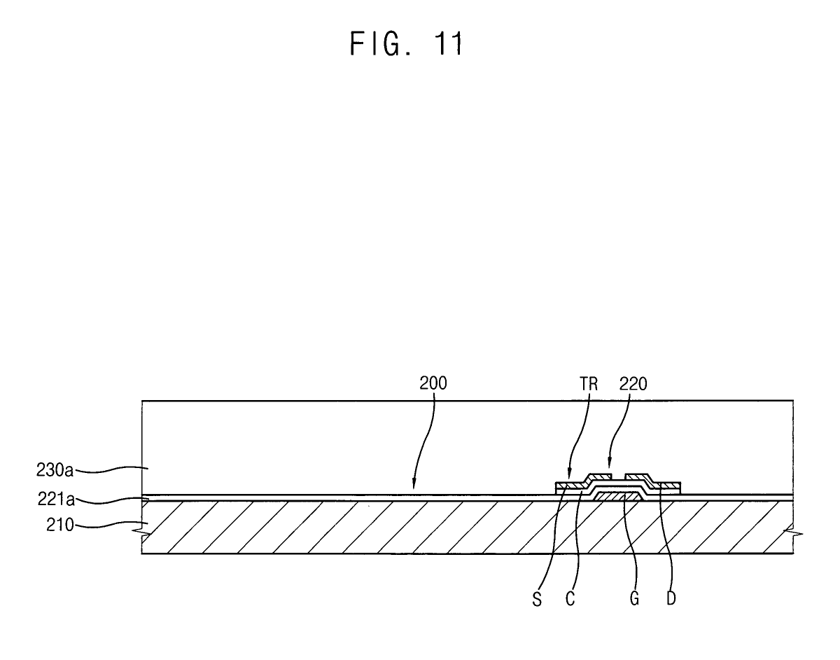

FIG. 10 is a cross-sectional view illustrating forming a voltage applying unit on a base substrate using a method of manufacturing a thin film transistor substrate in accordance with an exemplary embodiment of the present invention.

Referring to FIG. 10, a first signal line (not shown) is formed on the base substrate 210.

A metal thin layer is formed on the base substrate 210, and patterned using a photolithography method to form the first signal line on the base substrate 210. A gate electrode (not shown) is formed in the first signal line, and is extended along the base substrate 210.

When a thin film transistor substrate 200 has a resolution of about 1024×764, the first signal line including about seven hundred sixty four lines is formed on the base substrate 200. A turn-on signal or a turn-off signal from an exterior is applied to the first signal line.

An insulating layer 221a is formed on the base substrate 210 to cover the first signal line.

A channel layer ‘C’ is entirely formed on an upper face of the insulation layer 221a and patterned by a photolithography process, and thus the channel layer ‘C’ is formed on the insulation layer 221a to cover the upper face of the gate electrode ‘G’ of the first signal line. In the present embodiment, an amorphous silicon thin film is patterned to form the channel layer ‘C’.

The channel layer ‘C’ is changed to a conductor from a nonconductor by the turn-on signal from the first signal line, and is changed to the nonconductor from the conductor by the turn-off signal from the first signal line.

The second signal line (not shown) is formed on the base substrate 210. A metal thin film is entirely formed on the base substrate 210, and patterned by the photolithography process to form the second signal line on the base substrate 210. The second signal line is extended in a direction substantially perpendicular to the first signal line, and a source electrode ‘S’ is extended along the upper face of the base substrate 210. The source electrode ‘S’ is electrically connected to one side of the channel layer ‘C’. When the thin film transistor 200 has a resolution of about 1024×764, the second signal line includes 1024×3 lines. The second signal line receives a data signal from the exterior.

A drain electrode ‘D’ is formed on the base substrate 210 when patterning the metal thin layer by the photolithography process so as to form the second signal line. The drain electrode ‘D’ is electrically connected to a side that is an opposite side electrically connected to a source electrode ‘S’.

FIG. 11 is a cross-sectional view illustrating forming an organic layer on the base substrate using a method of manufacturing a thin film transistor substrate in accordance with an exemplary embodiment of the present invention.

Referring to FIG. 11, an organic layer 230a is formed on the base substrate 210. The organic layer 230a includes a photosensitive material, for example, positive type photosensitive material. The organic layer 230a covers voltage applying unit 220 formed on the base substrate 210. The organic layer 230a is formed by a method such as a spin coating, or slit coating.

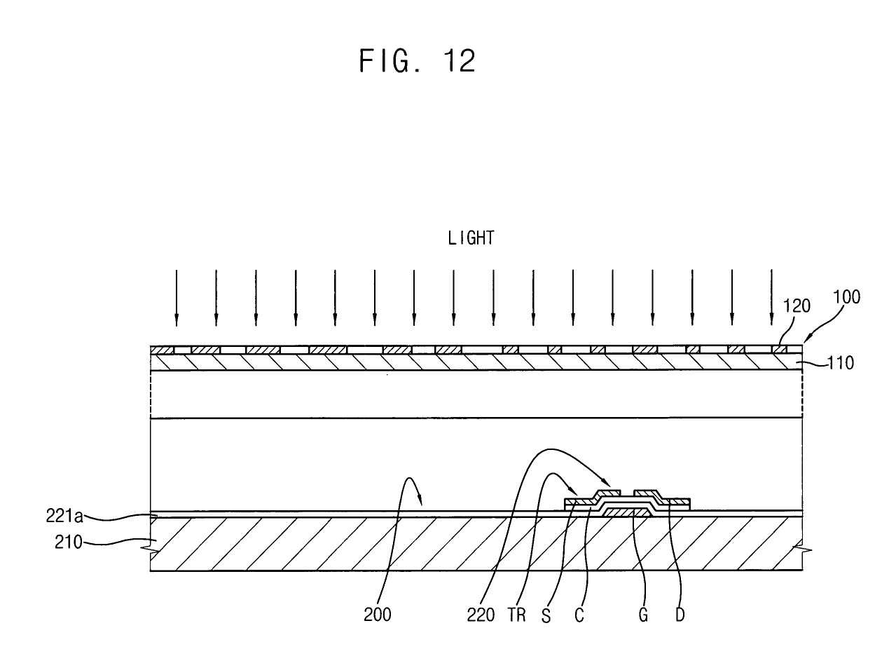

FIG. 12 is a cross-sectional view illustrating a mask positioned on the base substrate using a method of manufacturing a thin film transistor substrate in accordance with an exemplary embodiment of the present invention.

Referring to FIG. 12, a mask 100 is disposed above organic layer 230a. The mask 100 includes a transparent substrate 110 and a plurality of light blocking patterns 120. For example, the mask of the present embodiment has a construction suitable for developing the organic layer 230a.

The transparent substrate 110 includes a substrate having an excellent light transmittance. The transparent substrate 110 may include, for example, a glass substrate.

The light blocking patterns 120 may be formed on the transparent substrate 110 or beneath the transparent substrate 110. The light blocking patterns 120 partially block a light directed to the transparent substrate 110.

Therefore, a shape of the light passing between the light blocking patterns 120 is determined according to shapes of the light blocking patterns 120. Therefore, substantially same patterns of light blocking patterns 120 are formed on the organic layer 230a under the mask 100.

In the present exemplary embodiment, the light blocking patterns 120 are formed on the transparent substrate 110. The light blocking patterns 120 are formed on the transparent substrate 110 in a thin film type, and have a substantially island shape when viewed on a plane. That is, the light blocking patterns 120 have irregular shapes.

The light blocking patterns 120 have various shapes different from each other. The light blocking patterns 120, for example, each have a substantially polygonal shape such as a triangular shape, a quadrangular, a pentagonal shape, or a hexagonal shape when viewed on a plane. Alternatively, the light blocking patterns 120 may have a substantially circular shape or an oval shape when viewed on a plane.

For example, although all the light blocking patterns 120 have similar shapes, each side of the light blocking pattern 120 has a length at random so that the light blocking patterns 120 have different shapes from each other.

In addition, although all the light blocking patterns 120 have similar shapes, internal angles formed by neighboring two sides of the light blocking pattern 120 may be at random so that the light blocking patterns 120 have different shapes from each other.

Further, the light blocking patterns 120 may each have substantially polygonal shapes such as the triangular shape, the rectangular shape, or a mixture thereof, so that the light blocking patterns 120 have different shapes from each other. Each of the light blocking patterns 120 may have different side lengths, and the internal angles formed by neighboring two sides of the light blocking patterns 120 may be different.

The light blocking patterns 120 adjacent to each other are spaced apart from each other by a distance, for example a distance D as illustrated in FIG. 1. This distance is in a range of about 2.0 μm to about 4.0 μm. Also, the distance between the light blocking patterns 120 adjacent to each other are preferably substantially constant.

A size of the light blocking patterns 120 may be in a range of about 3.5 μm to about 5.5 μm, and is preferably in a range of about 4.0 μm to about 5.0 μm.

The distance between the light blocking patterns 120 adjacent to each other may be in a range of about 40% to 100% with respect to the size of the light blocking patterns 120.

The light blocking patterns 120 are formed on the substrate 110 in different shapes, and the light blocking patterns 120 have a size of about 3.5 μm to about 5.5 μm, so that the micro lens parts 232 also having different shapes from each other may be formed on the organic layer 230a disposed under the mask 100. In addition, a reflective electrode having the embossing pattern of substantially same shapes as the micro lens part 232, is formed on an upper face of the organic layer 230a, so that light properties of a light reflected from the reflective electrode may be enhanced.

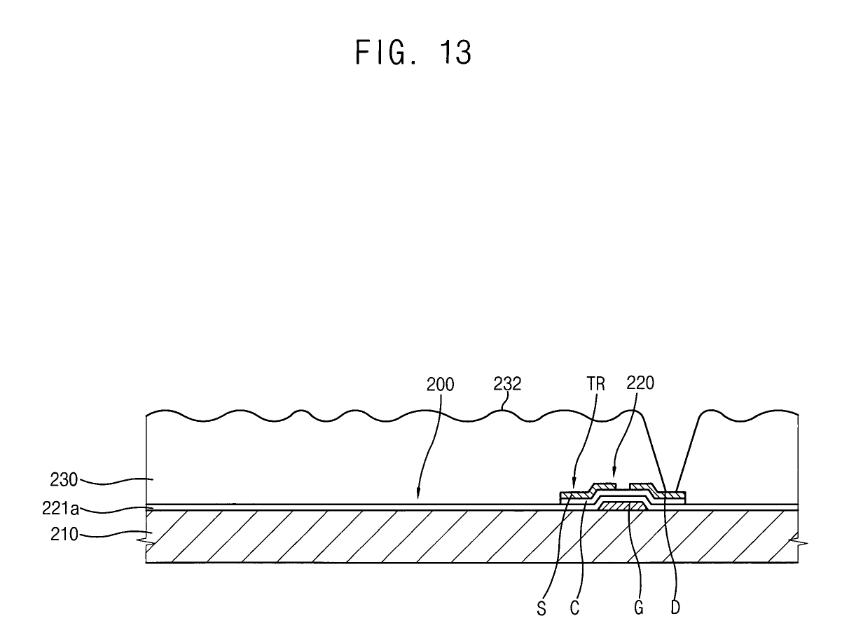

FIG. 13 is a cross-sectional view illustrating patterning the organic layer using a method of manufacturing a thin film transistor substrate in accordance with an exemplary embodiment of the present invention.

Referring to FIGS. 12 and 13, a light is provided to an organic layer 230a through a mask 100 disposed over the organic layer 230a to expose an upper face of the organic layer 230a. Then, the organic layer 230a is developed by a developing agent so that a micro lens part 232 is formed on the upper face of the organic layer 230a, and a portion corresponding to a drain electrode ‘D’ of a voltage applying unit 230a is opened to expose the drain electrode ‘D’.

A plurality of the micro lens parts 232 are formed on the organic layer 230a. Micro lens parts 232 are formed having the shape which correspond to the shape of the blocking patterns 120 which protect organic layer 230a from the light (FIG. 12). The micro lens parts 232 have substantially island shapes different from each other when viewed on a plane. That is, the micro lens parts 232 each have an irregular shape.

More particularly, the micro lens part 232 has a polygonal shape such as a triangular shape, a quadrangular shape, a pentagonal shape, etc. For example, the micro lens parts 232 may each have the island shape including a triangular shape, a quadrangular shape, a pentagonal shape, or a mixture thereof.

In the present embodiment, the micro lens part 232 has sides having different lengths from each other, so that each of the micro lens parts 232 has a different shape.

Alternatively, internal angles formed by neighboring two sides of the micro lens part 232 may be different from each other so that the micro lens parts 232 may have different shapes from each other.

Alternatively, all the micro lens parts 232 may each have a substantially same shape, but each micro lens part may have a different size.

The intervals between neighboring micro lens parts 232 are substantially constant, and the intervals between the neighboring micro lens parts 232 are in a range of about 2.5 μm to about 3.5 μm.

The size of the micro lens part 232 is in a range of about 3.5 μm to about 5.5 μm, and the size of the micro lens part 232 is preferably in a range of about 4.0 μm to about 5.0 μm. The sizes of the micro lens parts are defined using the same definitions described above for the size of the light blocking patterns 120.

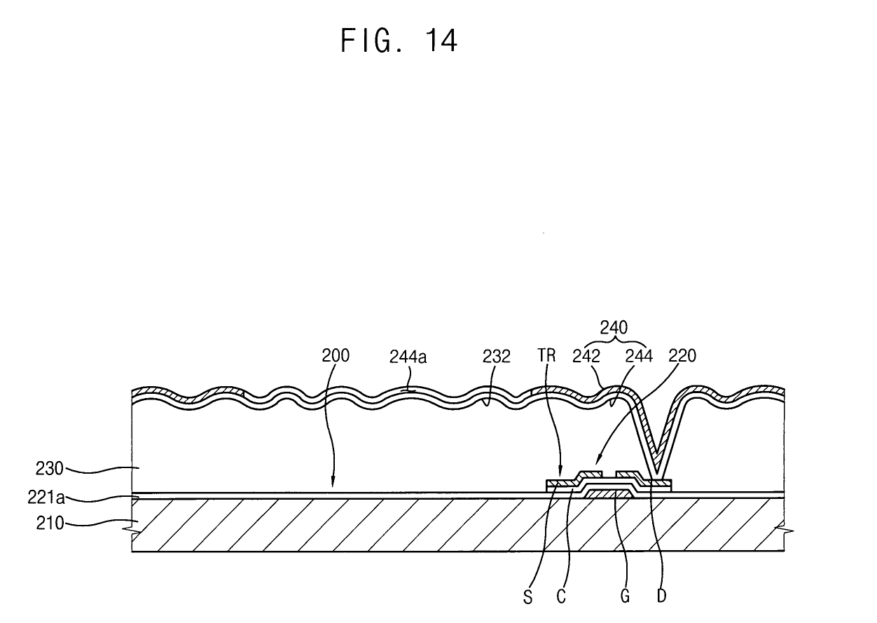

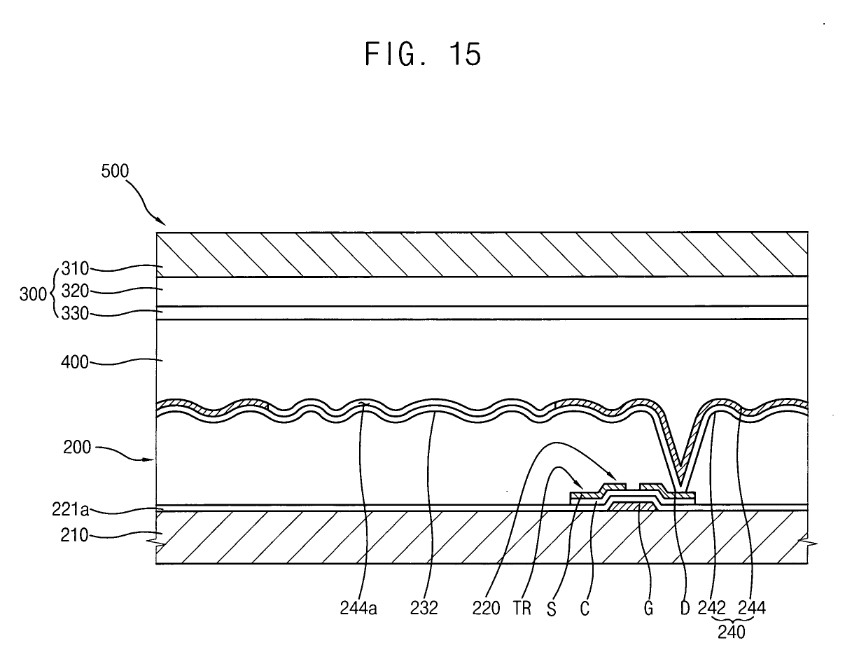

FIG. 14 is a cross-sectional view illustrating forming a pixel electrode on an upper face of the organic layer using a method of manufacturing a thin film transistor substrate in accordance with an exemplary embodiment of the present invention.

Referring to FIG. 14, the pixel electrode 240 includes a first electrode 242 formed on the organic layer 230a and a second electrode 244 formed on an upper face of the first electrode 242. In the present embodiment, the pixel electrode 240 includes the first and second electrodes 242 and 244; however, only the first electrode 242 may be formed on the organic layer 230a.

In the present embodiment, the first electrode 242 is directly formed on the first organic layer 230a. The first electrode 242 includes, for example, an indium tin oxide (ITO) film, an indium zinc oxide (IZO) film, or an amorphous indium thin oxide film.

The second electrode 244 is formed on an upper face of the first electrode 242. The second electrode 244 includes a metal having an excellent light reflectance. The second electrode 244 may be constructed of materials such as, for example, aluminum, or an aluminum alloy. The second electrode 244 has a transmitting window 244a to partially expose the first electrode 242.

An embossing pattern is formed on the first electrode 242 and the second electrode 244 that corresponds to the pattern of micro lens parts 232. The embossing pattern has a substantially same shape as the micro lens parts 232 since the embossing pattern is formed on the upper face of first electrode 242.

Display Apparatus

FIG. 15 is a cross-sectional view illustrating a display apparatus in accordance with an exemplary embodiment of the present invention. In the present embodiment, a thin film transistor substrate has a same function and structure as those of the thin film transistor in FIG. 2 except for the addition of a color filter substrate and a liquid crystal layer. In FIG. 15, the same reference numerals are used to refer to the same or like parts as those in FIG. 2 and any further repetitive descriptions will be omitted.

Referring to FIG. 15, a display apparatus 500 includes a thin film transistor 200, a color filter substrate 300 and a liquid crystal layer 400.

The color filter substrate 300 corresponds to the thin film transistor 200.

The color filter substrate 300 includes a transparent base substrate 310, a color filter 320 and a common electrode 330.

The color filter included in the color filter substrate 300 includes a red color filter, a green color filter and a blue color filter through which a red light, a green light and a blue light are transmitted, respectively. The color filter 320 corresponds to a pixel electrode 240.

The common electrode 330 is formed on the base substrate 310 to cover the color filter including the red, green and blue color filters. The common electrode 330 corresponds to the pixel electrode 240 formed on the thin film transistor substrate 200.

The liquid crystal layer 400 is disposed between the color filter 300 and the thin film transistor 200. The liquid crystal layer 400 changes an internal light passed through a transmitting window 244a of the pixel electrode 240 or an externally provided light passed through the color filter substrate 300 into the light that corresponds to an electric field formed between the pixel electrode 240 and the common electrode 330. Therefore an image including information may be displayed.

According to the above, an amount of light reflected from the embossing pattern formed on the reflective layer in the pixel electrode increases to improve an image display quality of the display apparatus.

Having thus described exemplary embodiments of the present invention, it is to be understood that the invention defined by the appended claims is not to be limited by particular details set forth in the above description, as many apparent variations thereof are possible without departing from the spirit or scope thereof as hereinafter claimed.

What is claimed is:

1. A mask comprising:
a transparent substrate; and
a plurality of light blocking patterns having irregular shapes positioned on the transparent substrate.

2. The mask of claim 1, wherein internal angles formed by two neighboring sides of the light blocking pattern are different from each other.

3. The mask of claim 1, wherein a distance between adjacent edges of ones of the light blocking patterns is in a range of from about 2.5 μm to about 3.5 μm.

4. The mask of claim 3, wherein the distance between adjacent edges of the light blocking patterns is substantially constant.

5. The mask of claim 1, wherein a size of the light blocking pattern is in a range of about 3.5 μm to about 5.5 μm.

6. The mask of claim 1, wherein the size of the light blocking pattern is in a range of about 4.0 μm to about 5.0 μm.

7. The mask of claim 1, wherein a distance between adjacent edges of the light blocking patterns is in a range of from about 40% to about 100% of an area of the light blocking pattern.

8. The mask of claim 1, wherein ones of the light blocking patterns have a polygonal shape.

9. A thin film transistor substrate comprising:
a base substrate;
a voltage applying unit positioned on the base substrate;
an organic layer comprising a plurality of micro lens parts formed on the organic layer to expose an output terminal of the voltage applying unit, each of the micro lens parts having an irregular shape; and
a pixel electrode comprising a first electrode formed on the organic layer and a second electrode formed on an upper face of the first electrode, wherein the second electrode includes a light transmitting window.

10. The thin film transistor substrate of claim 9, wherein the micro lens part has a substantially polygonal shape.

11. The thin film transistor substrate of claim 9, wherein side lengths of the micro lens part are different from each other.

12. The thin film transistor substrate of claim 10, wherein internal angles formed by two neighboring sides of the micro lens part are different from each other.

13. The thin film transistor substrate of claim 9, wherein a distance between the micro lens parts adjacent to each other is substantially constant, and the distance is in a range of from about 2.5 μm to about 3.5 μm.

14. The thin film transistor substrate of claim 9, wherein a size of the micro lens parts is in a range of about 3.5 μm to about 5.5 μm.

15. The thin film transistor substrate of claim 9, wherein the size of the micro lens part is in a range of about 4.0 μm to about 5.0 μm.

16. The thin film transistor substrate of claim 9, wherein a distance between the micro lens parts adjacent to each other is in a range of about 40% to about 100% with respect to a size of the micro lens part.

17. The thin film transistor substrate of claim 9, wherein the voltage applying unit includes a thin film transistor comprising an output terminal and a signal line electrically connected to the thin film transistor, and the signal line applies a voltage from the thin film transistor to the output terminal in a predetermined time.

18. A method of manufacturing a thin film transistor substrate comprising:
forming a voltage applying unit comprising an output terminal on a base substrate;
forming an organic layer on the base substrate to cover the voltage applying unit;
positioning a mask above a surface of the organic layer, the mask comprising a plurality of light blocking patterns having a plurality of sides, wherein each light blocking pattern is a substantially polygonal shape and further wherein the light blocking patterns have different lengths from each other;
exposing the organic layer with light through the mask to form micro lens structures on an upper surface of the organic layer, each of the micro lens structures having a different shape when viewed on a plane;
forming a first electrode on the upper face of the organic layer; and
forming a second electrode on the first electrode, the second electrode including a light transmitting window to partially expose the first electrode.

19. The method of claim 18, wherein ones of the light blocking patterns have a polygonal shape.

20. The method of claim 19, wherein a length of sides of ones of the light blocking patterns are nonuniform.

21. The method of claim 19, wherein internal angles between adjacent sides of ones of the light blocking pattern are nonuniform.

22. The method of claim 18, wherein a distance between adjacent edges of ones of the light blocking patterns is substantially constant, and the distance is in a range of about 2.5 μm to about 3.5 μm.

23. The method of claim 18, wherein a size of the light blocking pattern is in a range of about 3.5 μm to about 5.5 μm.

24. The method of claim 18, wherein the size of the light blocking pattern is in a range of about 4.0 μm to about 5.0 μm.

25. The method of claim 18, wherein a distance between adjacent edges of the light blocking patterns is in a range of about 40% to about 100% of a size of the light blocking pattern.

26. A display apparatus comprising:
a thin film transistor substrate comprising:
a first substrate;
a voltage applying unit formed on the first substrate;
an organic layer having a plurality of micro lens parts formed on the organic layer to expose an output terminal of the voltage applying unit, each of the micro lens parts having an irregular shape of a different size to increase a light reflectance; and
a pixel electrode comprising a first electrode formed on the organic layer and a second electrode formed on an upper face of the first electrode, wherein the second electrode includes a light transmitting window; and
a second substrate comprising a common electrode corresponding to the pixel electrode, the second substrate corresponding to the first substrate; and
a liquid crystal layer disposed between the first and second substrates.

27. The thin film transistor substrate of claim 26, wherein the micro lens part has a substantially polygonal shape.

28. The thin film transistor substrate of claim 27, wherein side lengths of the micro lens part are different from each other.

29. The thin film transistor substrate of claim 27, wherein internal angles formed by two neighboring two sides of the micro lens part are different from each another.

30. The thin film transistor substrate of claim 26, wherein the distance between the micro lens parts adjacent to each other is substantially constant, and the distance is in a range of about 2.5 μm to about 3.5 μm.

31. The thin film transistor substrate of claim 26, wherein a size of the micro lens part is in a range of about 3.5 μm to about 5.5 μm.

32. The thin film transistor substrate of claim 26, wherein the size of the micro lens part is in a range of about 4.0 μm to about 5.0 μm.

33. The thin film transistor substrate of claim 26, wherein a distance between the micro lens parts adjacent to each other is in a range of about 40% to about 100% with respect to a size of the micro lens part.
